(19) United States
(12) Patent Application Publication
(10) Pub. No.: US 2023/0057444 A1
(43) Pub. Date: Feb. 23, 2023

(54) Compressing network data using Deep Neural Network (DNN) deployment

(71) Applicant: Ciena Corporation, Hanover, MD (US)

(72) Inventors: Petar Djukic, Ottawa (CA); Ivan Radovic, Ottawa (CA); Maryam Amiri, Ottawa (CA); Jinxin Liu, Ottawa (CA); Burak Kantarci, Ottawa (CA)

(21) Appl. No.: 17/880,400

(22) Filed: Aug. 3, 2022

Related U.S. Application Data
(60) Provisional application No. 63/229,117, filed on Aug. 4, 2021.

(51) Int. Cl. G06N 3/08

(52) U.S. Cl. CPC G06N 3/08

(57) ABSTRACT

Systems and methods for compressing network data are provided. According to one implementation, a method includes the step of collecting raw telemetry data from a network environment. The raw telemetry data is collected as time-series datasets. The method also includes the step of compressing the time-series datasets by deploying the time-series datasets as a Deep Neural Network (DNN) in the network environment itself. The time-series datasets are configured to be substantially reconstructed from the DNN using predictive functionality of the DNN.

### CROSS-REFERENCE TO RELATED APPLICATION

The present application claims the benefit of priority to Provisional Application No. 63/229,117, filed Aug. 4, 2021, entitled “Storing network data with DNN memorization and network telemetry reduction by pruning and recovery of network data,” the contents of which are incorporated by reference herein.

### FIELD OF THE DISCLOSURE

The present disclosure generally relates to networking telemetry. More particularly, the present disclosure relates to systems and methods for compressing network data by deploying a Deep Neural Network (DNN) in the network such that the network data can be regenerated using the predictive nature of the DNN.

### BACKGROUND OF THE DISCLOSURE

Useful network data is high in volume, making it difficult to store for extended periods. For example, a network with a million data sources may generate 46Gb of one-minute sampled data in one day, which translates to 16Tb of data per year. While the number of data sources may seem high, even in a traditional Internet Protocol (IP) network, this number would be inside the realm of possibility when considering each flow to be a data source. The number of data sources would be much higher when considering cloud services, IoT networks with billions of devices, multiple network layers, or high sampling network measurements (e.g., state of polarization, or wireless SNR measurements).

Due to cost, network measurement data is not stored for extended periods, or it is aggregated in larger periods of time (e.g., daily, weekly, monthly, yearly), thus losing fidelity in an important historical record of what has happened in the network. The process of aggregation/averaging is a very crude way of lossy compression for time-series data. For example, averaging represents a time-series with a single number over a period, so its accuracy is not good.

Due to the large amount of storage typically required for time-series data, a special variation of a database, known as TimeScale Databases (TSDBs), have been developed to facilitate the storage, reading, and writing to the time-series data. TSDBs make use of chunks to divide time-series by the time interval and a primary key. Each of these chunks is stored as a table for which the query planner is aware of the chunk's ranges (in time and keyspace), allowing the query planner to immediately identify which chunks an operations data belongs to. Lossless compression is used to reduce the amount of data in TDSBs.

One of these compression schemes is XOR-based compression. XOR compression claims to achieve 1.2×-4.2× compression ratios of floating-point numbers, depending on the dataset used. In this algorithm, successive floating-point numbers are XORed together, which means that only the different bits are stored. The first data point is stored with no compression, whereas subsequent data points are represented using their XORed values, encoded using a bit packing scheme, which is covered, for example, in www.vldb.org/pvldb/vol8/p1816-teller.pdf. Regarding the XOR-based compression, the efficacy of the compression relies on subsequent values in the time-series being close to one another. That is, if consecutive values in the time-series are close to one another, then fewer bits will need to be stored to produce lossless compression.

Although there exist other compression tools for floating point numbers, they typically do not measure up to XOR based compression. For example, popular compression tools GZIP, LZF, and SZIP offer compression ratios of 1.25×, 1.18×, and 1.19×, respectively, when attempting to compress the floating-point representation of a sine wave. Other commercial compression schemes such as fpzip can achieve compression ratios of 1.5×-2.74×. It should be noted that all the aforementioned compression methods are lossless. For lossy compression, the ZFP compressor has been shown to achieve an average compression ratio of 4.41× with an accuracy (i.e., the number of bits in agreement between two floating-point numbers, whereby the lossless case corresponds to an accuracy of 64) of 34.1 for a 32-bit precision floating-point representation, and an 18.1 compression ratio with 21.0 accuracy gain for 16-bit representation.

However, the known solutions have several shortcomings. In the instance of lossless compression techniques, the compression ratios are typically less than an order of magnitude. Due to the immense quantity of time-series data that needs to be stored, these compression schemas, even if they are lossless, do not offer a sufficiently large compression ratio to justify their use. This becomes even more apparent when considering the overhead needed to constantly decompress stored time-series.

One attempt at data compression using Deep Neural Networks (DNNs) is known as semantic compression. Particularly, a state-of-art semantic compression approach is called DeepSqueeze. DeepSqueeze uses autoencoders for data compression of each row in a relational table. Autoencoders, for example, refer to a type of unsupervised artificial neural network used to learn efficient encodings or representations of unlabeled data by attempting to regenerate inputs from encodings.

The DeepSqueeze algorithm has a few shortcomings as well. The technique requires significant overhead in the form of training of multiple models and functions and storing all the weights associated with this multitude of models. It is designed to be used to compress rows of a relational table and not windows of a time-series. The algorithm is designed for tabular data and specifically for finding the correlation between different columns in such data, making it unfavorable for dealing with time-series. Based on published data, the performance of the algorithm is also several orders of magnitude lower than needed. Thus, this approach has no clear adaption for time-series data.

### SUMMARY OF THE DISCLOSURE

Systems and methods for compressing network data are provided. According to one implementation, a method includes the step of collecting raw telemetry data from a network environment. The raw telemetry data is collected as time-series datasets. The method also includes the step of compressing the time-series datasets by deploying the time-series datasets as a Deep Neural Network (DNN) in the network environment itself. The time-series datasets are configured to be substantially reconstructed from the DNN using predictive functionality of the DNN.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of a network data collection infrastructure.

FIG. 2A is a diagram of time-series storage using raw storage in a database.

FIG. 2B is a diagram of time-series storing using compresses storage with a DNN.

FIG. 3 is an example 3-layer DNN.

FIG. 4 is a diagram illustrating how an autoencoder can be used to generate an index.

FIGS. 5A and 5B are flowcharts of a process using a DNN to compress (FIG. 5A) and decompress (FIG. 5B) time-series data, such as from network measurements.

FIG. 6 is a diagram of key components of an IPFIX traffic measurement architecture.

FIG. 7 is a diagram of network data collection in the present disclosure.

FIGS. 8A and 8B are examples of time-series collection illustrating spatially correlated time-series (FIG. 8A) and time-correlated time-series.

FIG. 9 is a diagram of a pruning and reconstruction architecture.

FIGS. 10A and 10B are diagrams of pruning approaches including pruning with a pattern (FIG. 10A) and pruning randomly (FIG. 10B).

FIG. 11 is a diagram of a reconstruction approach.

FIG. 12 is a diagram of a DNN architecture for multi-variate reconstruction.

FIG. 13 is a graph comparing the approach in this disclosure to the performance of SVD based compression.

FIG. 14 is a diagram of the overall steps in the reconstruction process.

FIG. 15 is a diagram of the autoencoder process for a single time-series with the missing rate of 20%.

FIG. 16 is a diagram illustrating how residuals can be compressed.

FIG. 17 is a table showing notations using for different variables and descriptions of the variables.

FIG. 18 is a diagram showing an overview of a compression system.

FIG. 19 is a diagram of the decoder shown in FIG. 17.

FIG. 20 is a graph illustrating an example of uniformed quantization.

FIG. 21 is a table illustrating an example of datasets used for testing the compression system of FIG. 17.

FIG. 22 is a graph illustrating a comparison among different compression techniques using a specific dataset.

FIG. 23 is a table showing a comparison of the compression ratios of different compression techniques under a 0.1 MaAE.

FIGS. 24A-24E are graphs showing the effect of different variables on the compression ratio.

FIG. 25 is a table showing a comparison of compression ratio between univariate and multivariate modes.

FIGS. 26A and 26B are tables showing comparison between non-transfer learning and transfer learning under univariate and multivariate datasets.

FIG. 27 is a diagram illustrating a computing device for performing compression techniques.

FIG. 28 is a flow diagram illustrating a process for performing a compression technique.

### DETAILED DESCRIPTION OF THE DISCLOSURE

In various embodiments, the present disclosure relates to systems and methods for storing network data with Deep Neural Networks (DNN) “memorization” and network telemetry reduction by pruning and recovery of network data. The embodiments of the present disclosure improve upon conventional DNN techniques for compression and achieve much better lossy compression. Compressed measurements could be any number of network observations, such as packet counters, latency, jitter, Signal-to-Noise Ratio (SNR) estimates, State of Polarization (SOP) measurements, wireless Channel Quality Indicator (CQI) reports, alarm states, Performance Monitoring (PM) data, among other types of network data.

In the present disclosure, embodiments of systems and methods are described for “storing” network data in a DNN by deploying the DNN in the network, which greatly reduces the volume of information that needs to be stored. In this sense, data can be compressed by orders of magnitude, which is very useful for reducing the storage requirements on network data. There are multiple benefits to reducing the volume of measurement data produced in the network. For example, reducing data volume reduces the cost of storing the data once it arrives at the point of analysis. Also, reducing data volume reduces the cost of transferring data.

### Compression of Network Data

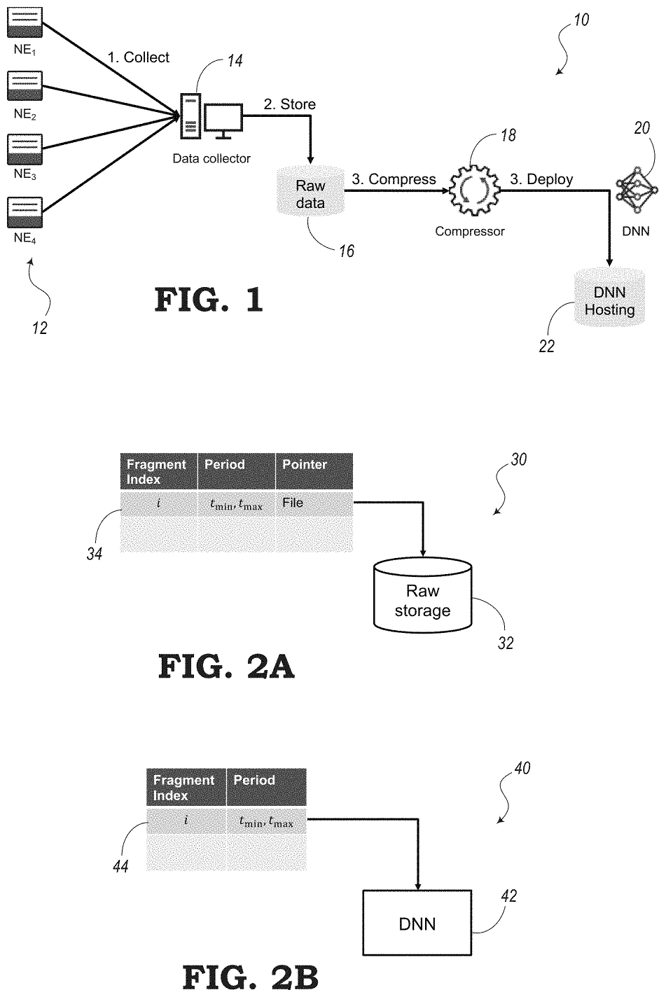

FIG. 1 is a diagram showing an embodiment of a system 10 for collecting, storing, and compressing network data. In this embodiment, the system 10 is illustrated as an example architecture for a network using a compression scheme. The system 10 includes a plurality of Network Elements (NEs) 12, which may be deployed in a network and may be configured to measure or obtain parameters of Performance Monitoring (PM) data related to the operational conditions of the network. Data from the NEs 12 is collected by a data collector 14, which is configured to store the raw network data in temporary storage database 16. The raw data is taken from the temporary database 16 and is compressed by a compressor 18. Instead of storing the compressed data in a database according to conventional strategies, the system 10 is configured to deploy the compressed data as a Deep Neural Network (DNN) 20, which can be deployed in a DNN hosting system 22, which may be configured as a server which hosts the DNN 20 and allows querying and retrieving of the compressed data.

Network data includes several (n) time-series ts₁, . . . , tsₙ sampled at the same rate. For network measurements, each time-series will have the same number of samples over the same period. The samples are pooled together into buckets, so tsᵢₖ=(x₁, . . . , xₚ) are the p samples collected in the kth period for time-series i. For network status (e.g., alarms), each time-series will have a number of indicators in the same period, so tsᵢₖ=(x₁, . . . , xₚ) could be the states of p alarms in the period, or the p alarm counts in the period.

Thus, the compression schemes, procedures, algorithms, techniques, methods, processes, etc. as described in the present disclosure include a unique sequence of steps that greatly improve prior compression attempts. Essentially, compressing data includes training a DNN model (e.g., DNN 20) and then configuring or deploying the compressed data as the DNN 20, instead of actually storing the compressed data in a database. As described herein, the compression strategy of the present disclosure includes obtaining or collecting the raw (telemetry) data in the form of time-series datasets. The telemetry data can be compressed in windows or chunks of time in the time-series data, which is different from conventional semantic compression (e.g., DeepSqueeze), which uses an autoencoder for data compression of each row in a relational table. However, in the present disclosure, instead of rows in a table, the operations are applied to the time-series datasets. Then, data can be “decompressed” (i.e., recovered, regeneration, etc.) from the DNN 20, such as by using the predictive functionality of the DNN 20.

Furthermore, the telemetry data is time-series data obtained from a communications network, where data may be related to network data, such as information or PM data related to packet count, latency, jitter, SNR, SNR estimates, state of polarization, Channel Quality Indicator (CQI) reports, alarm states, etc. Compression procedures, according to the present disclosure, may include the steps of 1) dividing the time-series data into equal-sized chunks (or periods of time), 2) feeding each index as an input to the DNN 20, where each chunk is an output of the DNN 20, and 3) training the DNN 20 to adjust weights until a desired compression ratio (or precision) is achieved. Decompression procedures, according to the present disclosure, may include the steps of 1) receiving an index corresponding to a desired time range, 2) inputting this index to the trained DNN 20, and 3) propagating values through the DNN 20 to obtain the reconstructed time-series chunk at the output of the DNN 20.

Before collecting and compressing the data, one or more telemetry devices (e.g., NEs 12) may be configured to prune the raw data before transmitting to raw data to the data collector 14. In some embodiments, this pruning process may include detecting a quality of a data decompression and providing a feedback signal to change the parameters of the pruning process in order to reduce the reconstruction error. For example, adjusting the level of pruning may use Reinforcement Learning.

In addition, the step of configuring compressed data as the DNN 20 may include the deployment of the DNN hosting system 22, which may be a server configured to host the DNN 20. In this case, the server may allow the querying of the DNN 20 for data retrieval, which effectively results in a reconstruction of the original raw data. Although this is a lossy compression scheme, the results described below demonstrate that the systems and methods of the present disclosure greatly improve conventional lossless or lossy compression strategies.

The DNN 20 may include indices and may further include relationships between each index and a time-series dataset. In response to receiving an index from a requesting agent, the DNN 20 is configured to reconstruct a time-series bucket related to that index. The indices may be picked randomly or according to a specific predetermined pattern. Also, in some embodiments, the indices may be determined through a bottleneck of an autoencoder.

Also, the DNN 20 may include multiple dense layers, as described below. The DNN 20 may also be configured as a decoder of an autoencoder, which is further described below.

Regarding compression, the system 10 may compress different time-series datasets at different compression rates and at different precisions (or accuracies) depending on the size of the data values (e.g., network traffic flow amount). The system 10 may use the compressor 18 as an autoencoder Bernoulli transformer to increase compression rate, by compressing time-series into Bernoulli distributed latent states and limiting (constraining) the distortion of reconstructed time-series.

Regarding decompression, the system 10 may decompress or reconstruct the data by using a transformation to the frequency domain. In some embodiments, the system 10 may determine “residuals,” which are the differences between the output and the original raw data. Then, the system 10 may then compress these residuals, as described in more detail below.

Furthermore, the system 10 may use a prediction-quantization-entropy coding scheme. For example, the prediction part of this may be for an autoencoder process and the quantize and entropy parts may be for the residuals. In some embodiments, autoencoding may include a Bernoulli Transformer AutoEncoder (BTAE), which may include an encoder acting as a feed-forward device and a decoder acting as a dictionary. The BTAE may be configured to reduce the size of the latent state by a factor related to the number of bits of floating point numbers used for the time-series values. Also, the system 10 may determine quantized entropy loss to constraint the size of the encoded residual with respect to the total entropy.

According to still other embodiments of the present disclosure, the telemetry data may be provided by an Internet Protocol Flow Information Export (IPFIX) device of one of the NEs 12, a router, switch, node, etc. of a communication network for providing network traffic information. The time-series datasets may be a collection of univariate and/or multi-variate time-series datasets. The step of configuring the compressed data as the DNN 20 may be a form of DNN memorization. Also, the time-series data may be deployed as the DNN 20 in lieu of storing compressed data in a database or in lieu of encoding comparisons between rows or columns in a relational table (as done in conventional systems). The training of the DNN 20 may include a stochastic gradient descent process. After training the DNN 20, the raw data can be discarded, since it can be effectively reconstructed by the strategies discussed below. Also, in some cases, the system 10 may be configured to reduce Mean Square Error (MSE) between the raw data and output of DNN 20 by increasing the number of iterations and/or by choosing hyper-parameters. Thus, the general aspects of the system 10 are described with respect to FIG. 1 and various details of further aspects of the system 10 are described below with respect to FIGS. 2-28.

FIG. 2A is a diagram of a time-series storage technique 30 using raw storage stored in a database 32. FIG. 2B is a diagram of time-series storage technique 40 which compresses storage with a DNN 42 (e.g., DNN 20). FIG. 2A shows how some conventional strategies may store data. Raw time-series are stored as fragments on a disk and a table 34 is used to relate times-series, periods, and the files on the disk. In contrast, FIG. 2B shows how data is stored into the DNN 42. A table 44 may be utilized to relate the time-series, periods, and fragments with “indices.” The DNN 42 contains the relationship between the index and the stored time-series. When an index is presented to the DNN 42, the DNN 42 reconstructs the time-series bucket for that index.

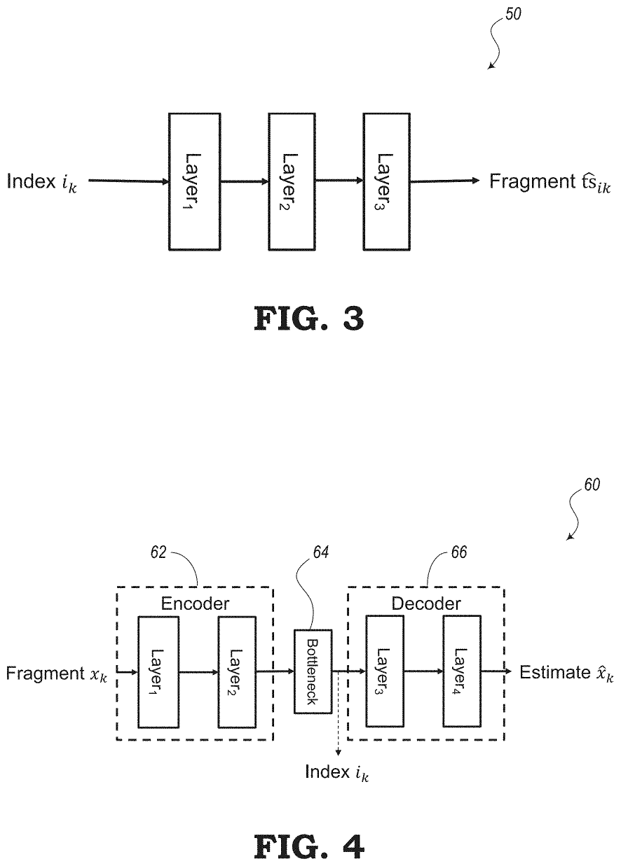

FIG. 3 shows an example of a three-layer DNN 50. Input to the time-series is the index of the bucket iₖ and the output calculated by the DNN 50 is the time-series bucket [symbol] ᵢₖ. It may be noted that, due to lossy compression, [symbol] ᵢₖ≠tsᵢₖ, but their difference can be made arbitrarily small ∥ [symbol] ᵢₖ−tsᵢₖ∥≤∈. Network data may be decompressed by using the predictive functionality of the DNN 50:

[symbol]

ᵢₖ=W₃ max{0,W₂ max{0,W₁iₖ+b₁}+b₂}+b₃

Compressing the time-series is done by training the DNN 50. During training, indices are used as the input to the DNN 50, and the raw time-series fragments are used as the desired output. The DNN 50 is trained to minimize the Mean Square Error (MSE) between the raw time-series and the output of the DNN 50 for a given index. Typically, the MSE is not 0. However, it can be made arbitrarily close to 0 by increasing the number of training iterations and by well-chosen training hyper-parameters. After the DNN 50 is trained, the raw time-series datasets can be discarded, since their information is contained in the DNN 50 itself.

### Indexing Strategies

The present disclosure describes and/or suggests at least two possible indexing strategies. The first strategy includes generating random integers for the index with a good ratio of 0s and 1s. For example, random 32-bit integers can be generated from 32-long vectors of Bernoulli random variables.

FIG. 4 is a diagram illustrating how an autoencoder 60 can be used to generate an index. The autoencoder 60, in this embodiments, includes an encoder 62, a bottleneck 64, and a decoder 66. Each of the encoder 62 and decoder 66 may include two layers. The autoencoder 60 can be used to generate an index. The bottleneck 64 of the autoencoder 60 can be made to be the size of the index (e.g., width 32). To use the output of the bottleneck 64 as the index, the data may be rounded to a space of (0,1) integers, which can be done with existing approaches (e.g., Zhenbo Hu, Xiangyu Zou, Wen Xia, Sian Jin, Dingwen Tao, Yang Liu, Weizhe Zhang, and Zheng Zhang. 2020. Delta-DNN: Efficiently Compressing Deep Neural Networks via Exploiting Floats Similarity. In 49th International Conference on Parallel Processing—ICPP (ICPP 20). Association for Computing Machinery, New York, N.Y., USA, Article 40, 1-12. DOI:doi. org/10.1145/3404397.3404408). It may be noted that the trained decoder 66 may be the DNN 42 shown in FIG. 2B.

One embodiment, which may be referred to as a preferred embodiment, can include the use of random indices. For example, this may be preferable for certain reasons, such as (1) the autoencoder 60 for a network might double the size of the network during training, meaning that it may need more training and would take longer to train than a network consisting of the compressor only (FIGS. 3) and (2) there may be no guarantee that the bottleneck 64 will produce unique indices, which may cause problems for data storage and retrieval.

### Compressing Based on Importance of Precision

The level of compression (i.e., compression ratio) may be related to the level of achievable precision. In general, the stronger the compression (i.e., data being compressed greatly), the less achievable precision is possible (i.e., data is not reconstructed as accurately). This means that the compression can be used judiciously to save on space and time to train the DNNs. When comparing compression algorithms, an important metric is the compression ratio, which is equal to the size of the uncompressed data divided by the size of its compressed form. For example, if the original size of a dataset is 16 MB and its compressed size is 4 MB, the compression ratio would be 4×.

For example, in many cases, the size of values in a time-series may vary significantly. Consider the case of “mice” and “elephant” flows in an IP network. There may be several orders of magnitude difference in the size of these flows. In the case of traffic engineering, it may be more important to know the size of large flows precisely than the size of small flows precisely.

The present disclosure describes systems and methods that can be used to compress small and large flows at different accuracies with different DNNs. Thus, more than one DNN can be applied, even on the same network data. For example, small flow measurements can be compressed with less precision, while big flow measurements can be compressed with higher precision. As the amount of measurement information per flow is the same for all flows and there are likely many more smaller flows than large flows, the systems of the present disclosure can achieve better results by storing the information at different compression ratios.

For example, if there are 100 small flows that can be compressed at 100 compression ratio and 1 large flow that can be compressed at compression ratio of 10, to maintain its acceptably high precision for each set of flows, the average compression ratio compression could be 91. This should be compared to compressing all flows at the compression ratio of 10, which the minimum required by elephant flows. It should be clear that using multiple compression ratios results in almost a magnitude less storage requirements.

### Processes

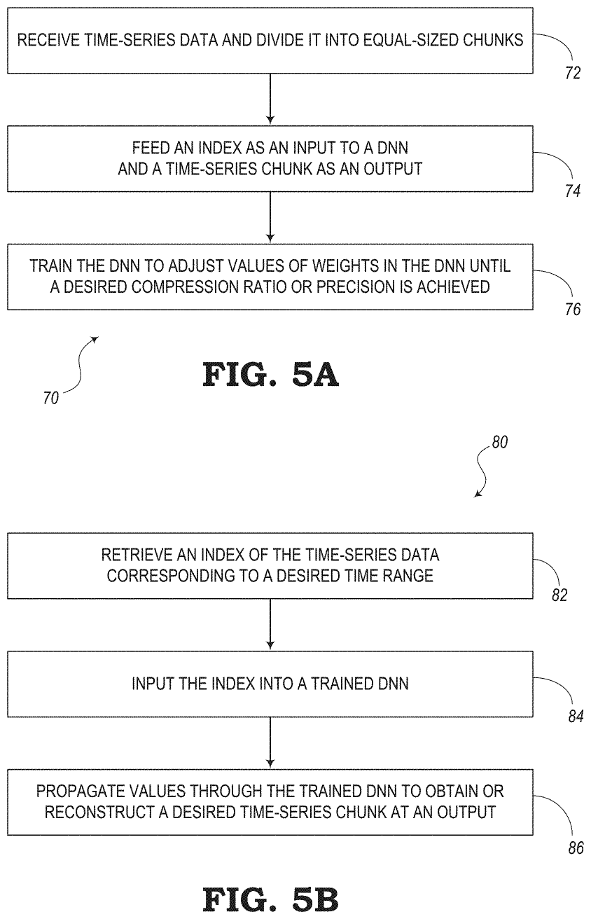

FIG. 5A is a flow diagram illustrating an embodiment of a process 70 using a DNN to compress data. FIG. 5B is a flow diagram illustrating an embodiment of a process 80 using a DNN to decompress data. In particular, the compressed or decompressed data may be time-series dataset, such as from network measurements (e.g., PM data). The processes 70, 80 may be implemented by a processing device (or processing system) where instructions (e.g., computer logic stored in memory) may be configured to cause or enable the processing device to execute certain steps. The instructions may be implemented in a non-transitory computer-readable medium and/or implemented in hardware in the processing device itself.

For compressing, the process 70 includes receiving time-series data and dividing it into chunks, as indicated in block 72. For example, the chunks may be periods of time and/or may be equal-sized time windows. Each chunk can be contiguous in time with adjacent chunks. The process 70 further includes feeding an index as an input to a DNN to get a time-series chunk as an output, as indicated in block 74. The index can be a time or some other means to uniquely identify a chunk. Finally, the process 70 may include training the DNN to adjust values of weights therein until a desired compression ratio or precision is achieved, as indicated in block 76. For example, the training can be a stochastic gradient optimization.

For decompressing, the process 80 includes retrieving an index of time-series data corresponding to a desired time range, as indicated in block 82. The process 80 also includes inputting the time-series index into a trained DNN, as indicated in block 84. Next, the process 80 includes propagating values (and calculating the values of output layers at each stage) until the chunk is reconstructed at the output of the DNN, as indicated in block 86.

Of note, multiple indices can be used to reconstruct a time-series containing multiple chunks and concatenating chunks from multiple indices to obtain reconstructed time-series. The trained DNN can be used to store measurements related to a network, such as packet counters, latency, jitter, signal-to-noise (SNR) estimates, state of polarization (SOP) measurements, wireless channel quality indicator (CQI) reports, alarm states, etc.

The DNN can be made of dense layers as described with respect to FIG. 3. Also, the DNN can be made of the decoder 66 of the autoencoder 60 as described with respect to FIG. 4. Each index can be picked randomly or uniquely. The index can be determined through the bottleneck 64 of the autoencoder 60. Furthermore, with respect to compression, the process 70 may take the compressed measurement, calculate the residual (e.g., difference between the output and input), and then compress the residual using a lossless compression technique.

### Simulated Results

During experimentation to analyze the efficacy of the DNN compression and decompression strategies described in the present disclosure, two datasets were used to check the performance of these compression schemes. A first dataset included a synthetic dataset, which was generated by creating uncorrelated polynomial degree-10 functions. This dataset allowed the performance of the present systems to be checked on very large sample sizes. It should be noted that this was a very challenging dataset. Each generated time-series had 768 floating point samples. The time-series were compressed to a randomly generated 32-bit integer, which was later used as an input to the DNN to regenerate the time-series.

The performance of various compression strategies is shown in the table below. For example, gzip and XOR are comparable lossless methods. It may be noted that replacing 15-minute bins with a single daily measurement is equivalent to a compression ratio of 96×. In the case of this time-series, the systems of the present disclosure were able to obtain a compression ratio of 113× with an average error of 3%. If, for example, the average error from the averaging of daily samples was 20% (not an unreasonable assumption), the equivalent reduction on this time-series using the present methods would be over 300×. As another example, at the Mean Absolute Percentage Error (MAPE) of 10%, the compression is over 200×, meaning that 1Gb of network measurements could be compressed to 5 Mb, if a 10% MAPE is acceptable.

| | MAPE | | | | | | | | | |
|---|---|---|---|---|---|---|---|---|---|---|
| | gzip | XOR | | | | | | | | |
| | (0%) | (0%) | 0.5% | 1% | 2% | 3% | 4% | 5% | 10% | 20% |
| Compression | 1.25 | 10.0 | 17.7 | 39.9 | 79.5 | 113.4 | 127.6 | 127.6 | 201.6 | 358.2 |
| Ratio | | | | | | | | | | |

Next, a collection of optical SNR estimates from a service provider was used. This dataset was fixed in size, so the compression ratio depended solely on the size of the neural network. In this dataset, 1% error is about 0.1 dB, which can achieve compression of over 20×. Better compression ratio might be expected if the dataset was larger. Again, gzip and XOR are comparable lossless methods.

| | MAPE | | | | | | | | | |
|---|---|---|---|---|---|---|---|---|---|---|
| | gzip | XOR | | | | | | | | |
| | (0%) | (0%) | 0.5% | 1% | 2% | 3% | 4% | 5% | 10% | 20% |
| Compression | 1.25 | 10 | 8.3 | 21.5 | 48.3 | 48.3 | 48.3 | 56.2 | 56.2 | 56.2 |
| Ratio | | | | | | | | | | |

### Network Telemetry Reduction by Pruning and Recovery of Network Data

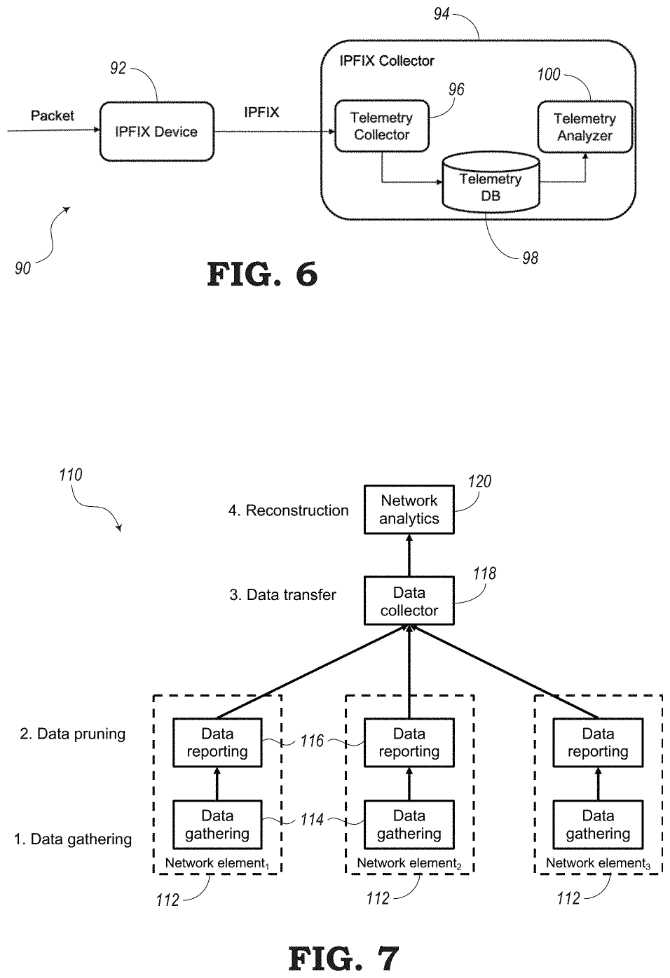

FIG. 6 is a diagram of showing an embodiment of an IP Flow Information Export (IPFIX) traffic measurement architecture. Generally, an IPFIX device 92 may be a part of routers or switches that report counter information about flows. A dedicated IPFIX device (e.g., the IPFIX device 92) could also be installed to capture packets from the fiber tap or the mirrored port at a switch. The IPFIX device 92 could be hardware based, or virtualized. An IPFIX collector 94 of the IPFIX traffic measurement architecture 90 may include a telemetry collector 96, a telemetry database 98, and a telemetry analyzer 100. The IPFIX collector 94 may be configured to gather and analyze IPFIX flows from multiple IPFIX devices 92 through reliable transport protocols. A typical IPFIX telemetry data record consists of 5-tuple of IP/TCP/UDP header fields, the number of bytes, the number of packets, the flow start time, and the flow end time. In IPFIX, communication traffic between the flow exporter and the flow collector is transmitted through reliable transport protocols such as Stream Control Transport Protocol (SCTP) or TCP2.

A traditional way of approaching the problem may require the installation of a specialized monitoring system with intermediate collectors, large volume data storage, and an enormous number of computational resources to analyze the collected data. The data volume problems start at the Network Element (NE) where the software and hardware are typically not able to track all flows passing the NE. Due to hardware limitations, the monitoring system may be unable to track much of the traffic.

### Techniques to Reduce Overhead of IPFIX

One practical approach to mitigate the collection overhead in IPFIX is a technique called threshold compression. In this technique, the router reports only flows above a threshold to the collection station (e.g., IPFIX collector 94). One possible disadvantage of this method may be that the information of flows below the threshold are not sent, while they may account for up to 90% of the flows. In conventional systems, the problem of large network data is resolved in unsatisfying ways, such as by reducing the pressure on the switch CPU, whereby flows are simply not reported. However, reported traffic flow data may not be transmitted out of the network. When transmitted to storage solutions, data may often be aged-out and deleted, and sometimes long-term summaries may be taken.

### CQI Measurements

In cellular systems, Channel Quality Indicator (CQI) measurements may be used to report User Equipment (UE) channel quality (e.g., SNR, MIMO channel estimates, etc.). Current standards mandate that these measurements are reported at a regular interval to ensure that the UE's channel is tracked sufficiently fast, especially when it is moving. If there are many UEs, the eNodeB may decide to reduce the frequency of the reports. If the frequency is reduced too much, the quality of transmission of the UEs may suffer, and outages may be possible.

### Reducing the Amount of Network Telemetry

The present disclosure provides implementations or approaches to reduce the amount of network telemetry. Although the problems discussed herein exist in current systems today, solutions may not usually be thought of outside of conventional approaches. However, with the advent of Artificial Intelligence (AI) approaches, especially in interpolation and imputation, new solution avenues, such as the embodiments discussed herein, are becoming available.

The problem of conventional systems, as described in the present disclosure, fits in the NetFlow and IPFIX architecture, as an example use case, but also in the context of 3GPP architecture where there is a large volume of network measurement data coming from network devices and the volume is so high that it may start to impact the available data bandwidth. The solutions to these problems in the NetFlow and IPFIX, as described herein, can also be used in any context where network telemetry is used.

NetFlow and IPFIX can be used to turn the network into a large collection of sensors collecting information about network traffic flows. Information about Internet Protocol (IP) flows can be used for monitoring of network usage, identification of misconfigured network elements, identifying of compromised network end points, and detection of network attacks (e.g., see Omar Santos, “Network Security with NetFlow and IPFIX: Big Data Analytics for Information Security,” Cisco Press, 2016). However, high fidelity network monitoring with technologies such as IPFIX comes with many challenges due to the amount of data that must be collected by NEs 12, then transmitted to where it can be stored and finally processed to get the insights that the operator is looking for.

FIG. 7 is a diagram showing an embodiment of a network data collection system 110. In this embodiment, the network data collection system 110 is configured to perform a method by which the amount of monitored network data transmitted by network elements is reduced with data pruning. The network data collection system 110 includes a plurality of NEs 112, each including a data gathering module 114 and a data reporting module 116. Similar to FIG. 1, the network data collection system 110 further includes a data collector module 118 configured to receive data from the NEs 112. Also, the network data collection system 110 includes a network analytics module 120.

Thus, data gathering and data reporting features are located on the NEs 112 and may be implemented in hardware to handle large volumes of data. The data reporting modules 116 are configured to transmit the data obtained by the data gathering modules 114 to the data collector module 118. Data is analyzed by the network analytics module 120, such as by using network analytics software. The network analytics module 120 may be configured to use Machine Learning (ML) to recover (or impute) the original data or a version that is close to the original data.

The data gathering modules 114 and data reporting modules 116 are configured to prune the data before it is transmitted to the data collector module 118. At any time, only a subset of the collected data is transmitted to the data collector module 118 for analysis or monitoring by the network analytics module 120. Pruning can be done by randomly dropping a data source for a period of time, randomly dropping portions of a dataset from a data source, or by using a periodic schedule to do either. The network analytics module 120 is configured to use ML to recover (impute) the missing data points. In this case, the imputation may work sufficiently because many of the time-series datasets produced in the network are highly correlated inside of a time-series dataset and across time-series datasets. Thus, the system 110 can prune the data to the point where reconstruction still works sufficiently. While the reconstruction may not be perfect, its performance is good enough for analysis tasks that might be examined with various reconstruction approaches.

It may be noted that despite showing this architecture in the context of IPFIX, the architecture of the network data collection system 110 would work particularly well in the context of Channel Quality Indication (CQI) measurements in wireless networks, where many users have correlated CQI measurements. Instead of a per-flow dropping, the data reporting modules 116 may instead be configured to drop CQI measurements per user.

The advantage of the network data collection system 110 of FIG. 7 is that the number of simultaneously monitored data sources can be substantially increased without overwhelming the hardware. It has been demonstrated that the telemetry data can be reduced and still the network data collection system 110 is able to recover the information in an acceptable range. In the context of IPFIX, the system 110 can be used in an IPFIX telemetry exporter to mitigate the collection overhead and reduce needed storage by pruning the data before transmitting the IPFIX flow to the data collector module 118 or telemetry collector. In the wireless context, the system 110 could be used to reduce the overhead of estimating and transmitting CQI measurements for all users.

### Operating Principles

Network data is sampled time-series data. The samples are taken at a prescribed measurement interval (typically in the order of minutes). When picking the sampling interval, the network operator is typically not concerned about sampling intervals from the point of view of the Nyquist criterion, as they are not trying to reconstruct the data at the point of the collection and processing. Data is collected for other purposes (e.g., forecasting, anomaly detection, etc.), so the precise reconstruction of the underlying random process may not be extremely important.

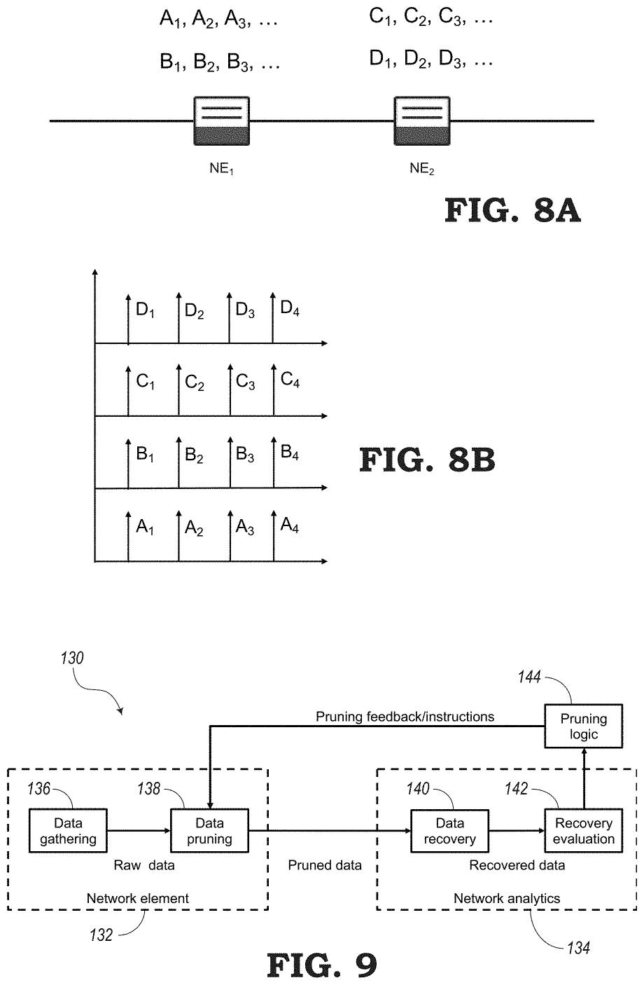

FIGS. 8A and 8B are examples of time-series collections illustrating spatially correlated time-series (FIG. 8A) and time-correlated time-series (FIG. 8B). Of note, the time-series datasets are multi-variate, denoted as A, B, C, D, and the time index is noted by the number 1, 2, 3, . . . . As an example of time-series collection, FIGS. 8A and 8B show two network elements and four time-series datasets. NE₁ collects time-series A and B, while network element NE₂ collects time-series C and D. Time-series dataset on the same element may be correlated. For example, datasets A and C might represent CPU usage on an element and datasets B and D might represent network utilization. As an example, it may be assumed that if network utilization is high, CPU usage is also high. Similarly, time-series datasets on the same path are correlated. So, if A is link utilization on NE₁ and C is link utilization on NE₂, they are correlated. For example, if network utilization on A is high, this could be due to a large flow traversing NE₁, which may also be traversing NE₂, so C may also be high.

To reduce the information generated and transmitted by NEs, the embodiments of the present disclosure may be configured to drop (i.e., prune) some of the samples. In some implementations, this may be referred to as “measurement sampling.” For example, the present systems may prune every k^{th} sample of each time-series dataset. This is called subsampling and can be undone for each time-series dataset using a low pass filter if the Nyquist criteria is satisfied for the subsampled time-series.

Furthermore, a “correlation” process may be used in the present systems. For example, “correlation” may refer to the situation where information about one time-series dataset may be available in another time-series dataset. This may be a result of using pruning processes and then imputing the missing information. The embodiments of the present disclosure may be configured to remove parts of a time-series so that some information is always available in another, correlated time-series. The information can be removed in many ways, but one of the easiest may be to use an offset between the time-series when the k^{th} element is removed. For the example in FIGS. 8A and 8B, the samples can be reduced by only sending A₁, A₃, B₂, B₄, and C₁, C₃, D₂, D₄. Since a low-pass filter might not be used in some embodiments, the systems can also be configured to remove elements randomly and attempt to recover the information later. Instead, the systems of the present disclosure may use a DNN-based imputation scheme.

Using the data available, the systems of the present disclosure were able to find multiple correlations in the datasets. Using correlation analysis on all the factors, the results showed that delay, jitter, packet loss ratio are highly correlated. This makes sense from network and queueing theory. From network theory, it may be understood that path and link delay are correlated to link utilization and that link utilization is correlated to end-to-end traffic.

Measurement sampling is an alternative technique that may be used in both packet and flow-based measurement to reduce the data volumes required to report. The main idea in this technique is to take only a subset of packets or flows out of all packets or flows to obtain reasonable result for the measurement. To do so, different selection mechanisms are introduced, including count-based sampling, time-based sampling, random sampling (uniform or weighted probability), etc. However, the main drawback of measurement sampling is the difficulty of determining the right sampling process and corresponding parameters according to the measurement conditions. Moreover, sampled data may not represent the characteristics of the real data. Also, using measurement sampling may introduce inevitable bias into results.

However, the embodiments of the present disclosure are different from measurement sampling in several aspects. First, in measurement sampling, data is reduced without considering the patterns existing in the data, while the present approach learns to reconstruct the reduced data based on the extracted patterns and features. Another major advantage of the present approach over the measurement sampling is that the present method can extract the patterns not only in time dimension, but also in spatial dimension. This is rather important as it is likely that there are significant correlations among datasets belonging to different flows. This correlation can be exploited fully in the present approach to reduce the amount of reporting data, while it is typically ignored in measurement sampling.

### Pruning and Recovery Architecture

FIG. 9 is a diagram of an embodiment of a system 130 for pruning and reconstruction. The system 130 includes NE 132 and network analytics device 134, similar to the architecture of FIG. 7. The NE 132 includes a data gathering module 136 and a data pruning module 138. The network analytics device 134 includes a data recovery module 140 and a recovery evaluation module 142. The results of the recovery evaluation module 140 are provided to pruning logic 144, which is configured to provide pruning feedback and instructions back to the data pruning module 138 of the NE 132 for adjusting the data pruning characteristics.

First, the data pruning module 138 is configured to receive the data from the data gathering module 136 and remove some portion of the data before transmitting the pruned data to the network analytics device 134. In the network analytics device 134, the data recovery module is next configured to reconstruct (impute) the data and pass it to the recovery evaluation module 142. Then, the recovery evaluation module 142 is configured to determine if the recovery was of high enough quality. Finally, the pruning logic is configured to instruct the data pruning module 138 on how to prune data to improve performance.

Depending on the quality of recovery as detected by the recovery evaluation module 142, the pruning logic 144 may instruct the data pruning module 138 to a) reduce or increase the amount of pruned data, b) change a pruning strategy (e.g., from a random process to a patterned process), and/or other factors. It should be understood that other kinds of changes could also be sent by the pruning logic 144 to the data pruning module 138 to control pruning strategies as desired.

### Data Pruning

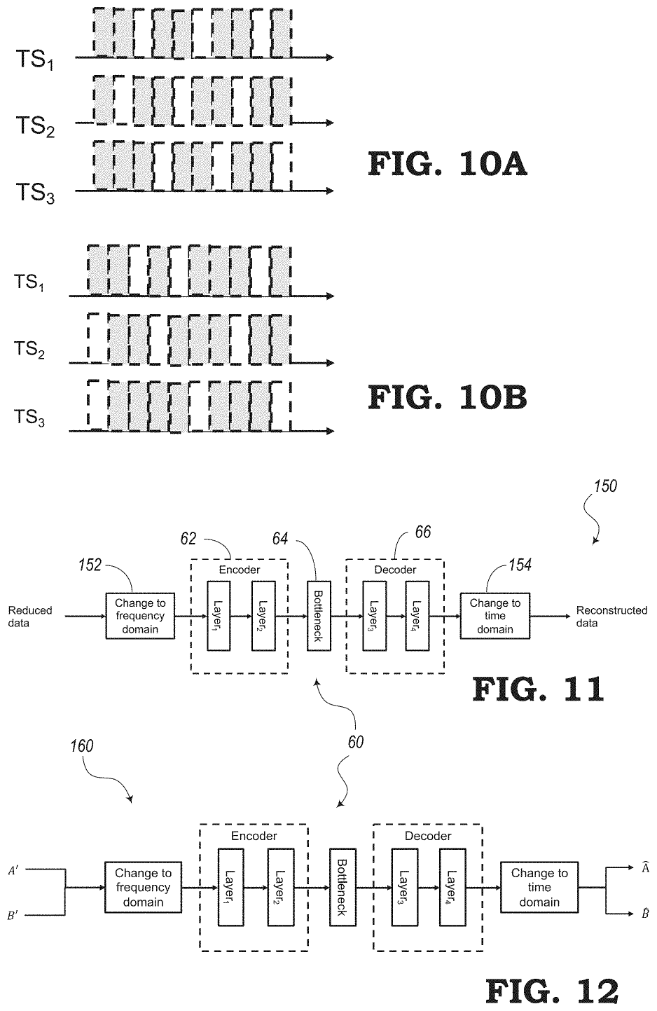

FIGS. 10A and 10B are diagrams of pruning approaches including pruning with a pattern (FIG. 10A) and pruning randomly (FIG. 10B) which could be used for pruning data. The shaded blocks represent data elements or values that are untouched, while the white blocks represent data elements that are pruned (removed). In these examples, only three time-series datasets are shown, which may be assumed to be correlated. The examples show different pruning patterns, designed to be applied over the three time-series datasets together. FIG. 10A shows an example where measurements are removed with a pattern, while FIG. 10B shows an example where measurements are removed randomly. Note that the advantage of using a pattern is that it can guarantee that there is data available across many time-series at any given time, while this might only be achieved with a high probability for random patterns.

Example of Data Reconstruction with Denoising

FIG. 11 is a diagram of a reconstruction approach that may be performed by a system 150. The system 150 includes the autoencoder 60 of FIG. 4, which in turn includes the encoder 62, bottleneck 64, and the decoder 66. There may be many ways of imputing the missing values received from the network elements. For example, one way of doing this may include a method that treats the missing values as noise in the data and can therefore work with any pruning strategy. The method does not require any information about how the data was pruned. As an example of reconstruction, FIG. 11 shows how to reconstruct missing values in a single-variate time-series. This strategy may also be extended to multi-variate time-series as well. The methods may be used where the pruning strategy is known before the reconstruction. The methods can be used on their own for time-series imputation even without the present context.

The system 150 is configured to perform the reconstruction method by accepting reduced data as an input and providing reconstructed data as an output. The system 150 treats missing values as noise and may use denoising method (e.g., the autoencoder 60). As certain values are missing, the reduced data is applied to a transformer 152. The transformer 152 is configured to receive the reduced data, which is first transformed in the frequency domain (e.g., using an inverse Fourier transform) or in the wavelet domain (e.g., using a wavelet transform). The transform into the frequency domain interlaces the missing and present values and so the structure of the data is pronounced even if some of the values are missing. The autoencoder structure denoises the frequency representation of the data, thus emphasizing the structures in the data. The inverse Fourier transform then returns the denoised frequency domain data into the time domain using a second transformer 154.

FIG. 12 is a diagram illustrating an embodiment of a DNN system 160 having an architecture for multi-variate reconstruction. The DNN system 160 may include similar elements as the system 150 of FIG. 11 but is configured to emphasize the multi-variate nature of the approach. The input to the DNN system 160 is two pruned time-series A′ and B′. During training, the DNN may be given samples of full time-series A and B at the output, so it may be configured to learn how to correct the missing values by taking advantage of the correlations between the two time-series datasets. During inference, the DNN estimates the true values of the time-series with A and B.

The method associated with the DNN system 160 of FIG. 12 can be implemented as either a set of function calls to (1) Fourier transform, (2) autoencoder, (3) inverse Fourier transform, a single DNN with the appropriate layers, or others. As described below, data can be obtained and self-labeled to enable training. Training a DNN is an automated procedure that exists in many open-source software (e.g., KubeFlow, etc.). For example, training may include (1) collecting representative data, (2) pruning the data offline, and (3) fitting the model to minimize the reconstruction error of the pruned data. As an example, the representative data may be collected in full day, one day per week. The training procedure may be performed offline and may include an algorithm by which the data was pruned on the box (or in line). The first step in the training procedure may be to prune the data offline and produce training (e.g., for the first six days) and then test the dataset (e.g., on the seventh day). The two datasets may be used to train the network in reconstructing the data later pruned on-box. Given the known pruning procedure and the full data, the DNN system 160 may be configured to create a self-labeled dataset. For example, since the pruned data values may be known, these values may be used at an output of the network during training and testing, and the input data may be the pruned measurements. The training procedure may then be set up to minimize the Mean Square Error (MSE) or minimum square error between the reconstructed missing values and the pruned values.

To validate the accuracy of the reconstruction process, the network elements may be configured to transmit the full data periodically. For example, once a week, the network elements may transmit the full dataset over any suitable period of time (e.g., about one hour, two hours, a full day, etc.). This dataset may be used to repeat the self-labeling procedure, producing a validation dataset. The validation dataset is used to ensure that the performance of the DNN system 160 is still accurate. In some embodiments, the autoencoder 60 (e.g., encoder 62, bottleneck 64, and decoder 66) may be made from layers of Long Short-Term Memory (LSTM), convolutional or “dense” DNN blocks, etc.

### Communicating the Pruning Levels

The communication between the data pruning module 138 and the pruning logic 144 in FIG. 9 may include communicating the changes in the pruning strategy, rates of pruning for the random strategy, the pattern of the pruning, and/or other changes. There are multiple ways which can be used to instruct the pruning module how to prune. One way to increase and decrease the rates of pruning is to use the multiplicative decrease and additive increase in pruning to slowly reduce pruning rate, while quickly decreasing it. The pruning rate is increased when the reconstruction process is returning several periods of low errors and decreased when the reconstruction process returns a period of high errors. The data pruning module 138 may be configured to send unpruned samples occasionally to monitor the performance of the reconstruction process.

One embodiment for adjusting the rate of pruning is by using a fixed threshold, as suggested above. However, there may be other ways of doing this as well. For example, the system could use Reinforcement Learning (RL) to automatically adjust the level of pruning in each of the time-series datasets. The RL system may decide for each time-series to increase or decrease the pruning rate taking the input of the reconstruction process into consideration. With the RL approach, the policy for increasing or decreasing of the pruning is found automatically through the process of trial and error. Unlike the process described above where a fixed threshold is used to decide when to increase or decrease the pruning, the RL approach may determine when to increase or decrease the threshold. For example, the RL approach may be using a policy which determines when to increase, decrease, or leave threshold alone. The input to the policy could be the current error in the reconstruction of the data or the data itself. The policy is determined through a process of exploration, which could be done on live traffic or in simulation. To find a better policy, the RL framework may use cost function, which may be trained to minimize a weighted total error across all reconstructions of the data. Therefore, every time a policy is used, the RL framework may be configured to measure the error of the reconstruction and add it to the total error observed from the policy up to that point. Over time, the RL may learn which policy works the best or may find policies that are improvements over others.

### Simulated Results

For evaluating the performance of the data reduction systems and methods of the present disclosure, publicly available network traffic trace information was used from an IP backbone network and a private dataset was also used. The public dataset included IP-level traffic flow measurements collected from every Point of Presence (PoP) in the IP backbone. The data was sampled flow data from every router for a period of six days (e.g., Apr. 7 to 13, 2003). For the private dataset, five-minute telemetry data for a five-day period was used.

The table below show the performance of the network data reduction approach of the present disclosure:

| | Data Reduction | 5% | 10% | 20% | 25% | 30% |
|---|---|---|---|---|---|---|
| Abilene | MAPE | 4% | 5% | 9% | 13% | 17% |
| ROA private | | 6% | 9% | 14% | 18% | 21% |

An acceptable error for this dataset is in the range of 15-25% for the purposes of traffic engineering, whereby the maximum data reduction of 25% may be expected. Using random data removal and imputation techniques outlined in the present disclosure, favorable results were achieved, while it may be expected that the performance of the embodiments of the present disclosure may be even better with a more sophisticated approach to pruning and more data for training the model.

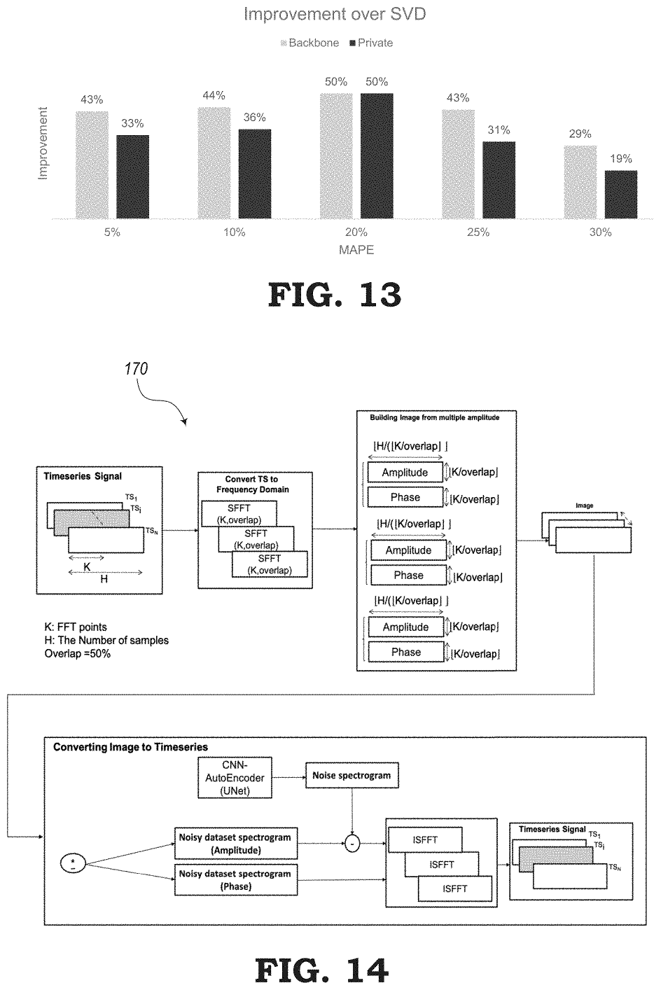

FIG. 13 is a graph comparing the embodiments of the present disclosure to the performance of Singular Value Decomposition (SVD) based compression. The improvement is measured as a percentage reduction in MAPE. As can be seen in FIG. 13, the present embodiments are able to reduce the MAPE by 19%-50%, which is a large improvement over conventional systems. Also, as mentioned above, it can be expected that the systems and methods of the present disclosure may provide even better results for DNN implementation with more available data, while the conventional SVD approach would not improve with more data.

### Details of the Reconstruction Process

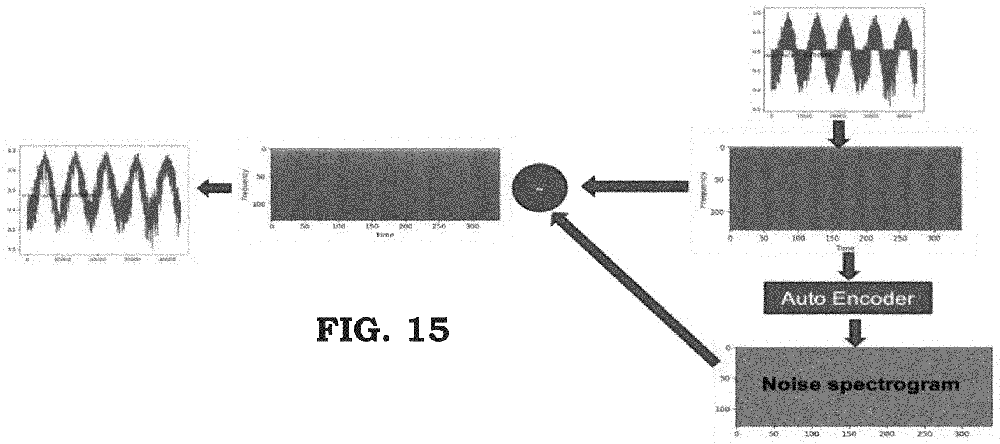

FIG. 14 is a diagram of an embodiment of a system 170 configured to perform a reconstruction process. As illustrated, the system 170 may be configured to carry out reconstruction based on a spatio-spectral decomposition of time-series and applying a Convolutional Neural Network (CNN) to predict missing data from the observed samples. The CNN, for example, may be any suitable class of deep learning methods. Also, FIG. 15 is a diagram of the autoencoder process for a single time-series with the missing rate of 20%.

Firstly, the system 170 may convert time-series datasets to time-frequency decompositions. Among the time-frequency decompositions, the system 170 may use spectrograms to represent a time-series dataset as a 2D image. In the resulting image, vertical and horizontal axes may represent frequency and time. The sequences of Short Time Fourier Transform (STFT) (i.e., frequency components) may be shown for a long time. Brightness of each pixel shows the strength of a frequency component at each time frame as depicted in FIG. 15.

In a next step, the system 170 may apply the CNN autoencoder deep learning approach to predict the noise model. In this case, the noise may be considered as artifacts generated by the missing data. The autoencoder can be used to capture the noise models for both magnitude and phase spectrograms. However, as a magnitude spectrogram contains most of the structure of the signal compared to a phase spectrogram, the system 170 may use just magnitude spectrograms to obtain the noise model, but phase spectrogram may also be kept for reconstructing the time-series datasets. Finally, the noise spectrogram computed by the autoencoder ay be reduced from the amplitude spectrogram of the noisy data set, which is the dataset with the missing value. The resulting spectrogram and the original phase spectrogram may be converted to time domain using inverse Short Time Fourier Transform (ISTFT).

### Training the Autoencoder

According to some embodiments, the autoencoder 60 (at least the encoder 62 and decoder 66) may be placed in a router of a communications network. A set of samples from time-series may be selected in a way such that the system 170 will have enough samples to perform a frequency conversion. These samples may then be used for the training. Training is performed locally at the router, which may be configured to compute the weights of the decoder 66 being sent to a collecting server (e.g., data collector 14, IPFIX collector 94, data collector 118, etc.) to be used in the decoder 66 residing in the collecting server.

It should be noted that the collecting server may just have the decoder network for reconstructing the compressed data and retrieve the original samples. In the training phase, the steps like the ones in Denoising Autoencoders (DAE) can be used. However, the ratio of data corruption may be equal to the target compression rate. In this way, local DAE learns how to reconstruct data from partially corrupted data.

### Compressing the Residuals

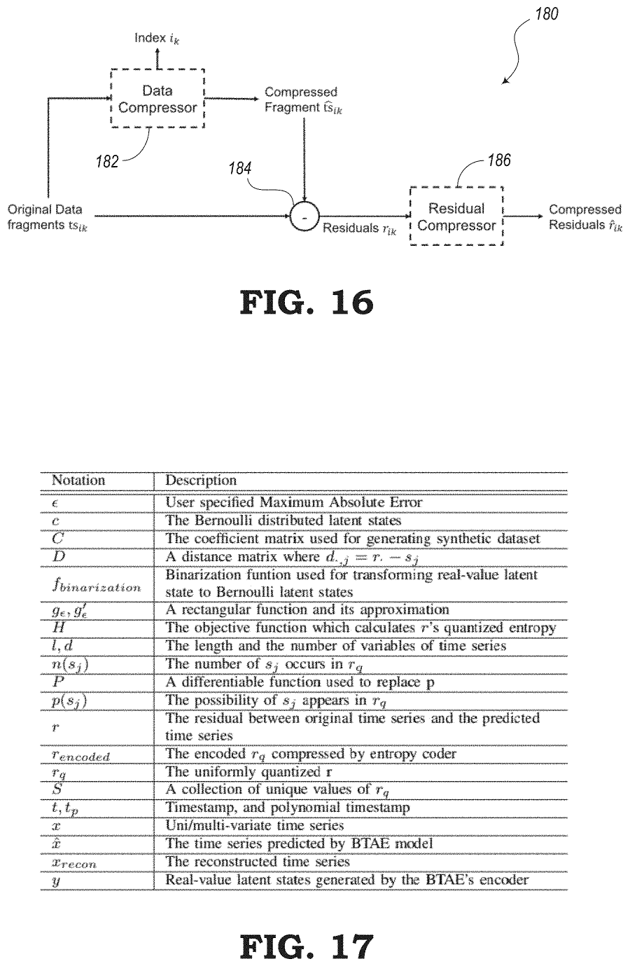

FIG. 16 is a diagram illustrating an embodiment of a system 180 demonstrating how residuals can be compressed. As shown, the system 180 includes a data compressor 182, which may represent any suitable data compression module, such as those described in the present disclosure. Original data fragments are provided to the data compressor 182 to obtain compressed fragments. The original data is also provided to a subtraction unit 184, which is configured to subtract the compressed fragments from the original data fragments for finding residuals. The residuals are processed by a residual compressor 186, which is configured to compress the residuals and provide compressed residuals as an output. Thus, not only is the “error” obtained, which is related to the residuals, but also this error is compressed to reduce storage needs for these parameters that can be used for evaluating performance.

Thus, in addition to compressing the original data, it is also possible to compress the residuals. It may be understood that the residual is the difference between the network output and the original data: rᵢₖ=tsᵢₖ′−tsᵢₖ and the DNN can be trained so that the residuals are small rᵢₖ≤∈. However, the system 180 can also further use lossless or lossy compression on the residuals to reduce the error further. In this process, data is compressed first. Second, the compressed data is used to determine the residual. Next, the residual is compressed separately with either lossy or lossless compression. In the case of lossless compression, the residual values may be quantized and then compressed using a compressor specific to the data. For example, an entropy encoder can be used for optimal results.

### Deep Learning-Based Lossy Time-Series Compression

A deep learning-based lossy time-series compression technique is further described with respect to the multiple embodiments of the present disclosure. In this section, a new compression technique is proposed, which is referred to herein as “Deep Dict” alluding to the deep learning in an encoding phase and using a dictionary-type function in a decoding phase. Deep Dict provides a novel lossy time-series data compression technique configured to improve the compression ratio.

Deep Dict may include a new framework configured for lossy compression of time-series data. The results demonstrate that Deep Dict achieves a higher compression ratio than state-of-the-art compressors. Deep Dict may be configured as a novel Bernoulli Transformer-based AutoEncoder (BTAE) or a BTAE-based lossy compressor that can effectively reduce the size of latent states and reconstruct time-series from the Bernoulli latent states. By aiming at further performance improvement, a new loss function, referred to as Quantized Entropy Loss (QEL), is also introduced in this section, which considers the characteristics of various compression problems and outperforms common regression losses such as L1 and L2 in terms of the compression ratio. QEL is applicable to any prediction-based compressors that utilize uniform quantization and entropy coder. The Deep Dict technique was tested on ten time-series datasets across a variety of domains. As demonstrated by the results, Deep Dict outperformed the compression ratio of the state-of-the-art lossy compression methods by up to 53.66%.

With the rapid rise of smart devices, sensors, and IoT networks, massive amount of time-series data are generated continuously. Thus, as suggested above, reduction of the time-series data volume through compression is critical so as to save network bandwidth and storage space. The intrinsic noise of time-series datasets can enable lossy compression to improve the compression ratio significantly when compared to lossless compression.

Again, massive amounts of time-series data may be created, stored, and communicated as a result of the widespread use of smart devices, industrial processes, IoT networks, and scientific research. Various domains (e.g., finance, stock analysis, health monitoring, etc.) benefit from high resolution time-series datasets. However, transmitting such a large number of time-series datasets can be costly in terms of network bandwidth and storage space. Consequently, many studies focus on compressing time-series datasets with a high compression ratio. Data compression can be roughly classified in two categories: lossless and lossy compression. Lossless compression permits flawless recovery of the original time-series, whereas lossy time-series compression can achieve a considerably higher compression ratio without significantly compromising downstream tasks due to the inherent noise of lossy time-series datasets.

AutoEncoder (AE) may be used as a lossy time-series compression technique. An AE encodes time-series data as latent states with real-values and decodes them as a prediction. Compressed latent states are one of the sources of overhead for compressed data. This section of the present disclosure addresses the potential of encoding time-series datasets into Bernoulli distributed latent states rather than real-value latent states in order to drastically reduce the size of latent states and improve compression rate. In addition to AE, prediction-based compressors typically employ regression losses. This study formulates a new loss to more accurately describe the problem based on the nature of entropy coders.

Based on a comparison with existing compression techniques, it was discovered that the systems and methods, as proposed in the present disclosure, may be configured to utilize a prediction-quantization-entropy coder paradigm, and may use Deep Dict to enhance prediction abilities. The embodiments of the present disclosure can greatly reduce the size of latent states in comparison to conventional AutoEncoder-based compressors. Loss functions for conventional prediction-based compressors are L1/L2. However, the embodiments of novel loss functions (e.g., QEL) are configured to improve the compression ratio of conventional systems, which has certain drawbacks of conventional regression losses. A prediction-quantization-entropy coding scheme may be utilized for lossy signal, picture, and video compression, where QEL may be suitable for compressors that use uniform quantization.

Again, time-series datasets are described as a collection of time-dependent data that can be categorized broadly into Univariate Time-series (UTS) and Multivariate Time-series (MTS). Univariate time-series datasets UTS ∈ [symbol] ^{l} contain a single variable that varies over time, whereas Multivariate time-series datasets MTS ∈ [symbol] ^{l*d} contain multiple variables that are not only related to timestamp but also dependent on one another, where [symbol] is the length of a time-series and [symbol] is the number of variables. AutoEncoder (AE)-based compressors encode time-series into a latent representation consisting of floating-point numbers. Thus, the size of the latent representation has a direct effect on the compression ratio. Deep Dict is a new compressor which compresses time-series (UTS/MTS) into Bernoulli distributed latent states, significantly reducing the size of latent states, and limits the distortion of reconstructed time-series.

For evaluating lossy time-series compression, two key metrics are used: data distortion and compression ratio. Data distortion measures the error between the original and reconstructed time-series, including the mean square error, the mean absolute percentage error, and the maximum absolute error. Maximum Absolute Error (MaAE) is a widely accepted measure of distortion in the absence of downstream tasks or domain knowledge. Compression ratio is defined as the ratio of original data size to compressed data size. FIG. 17 is a table showing notations using for different variables and descriptions of the variables.

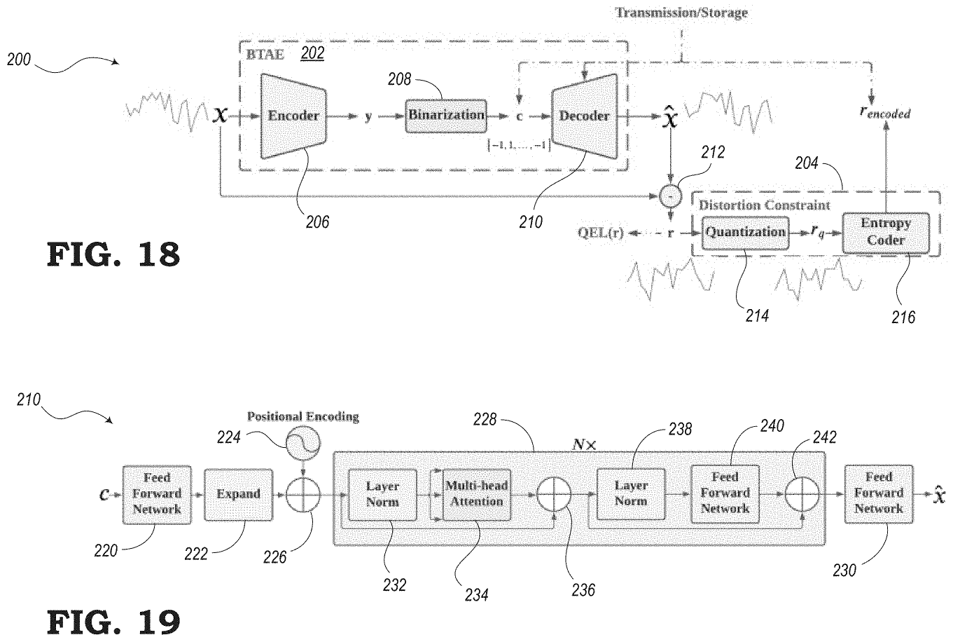

FIG. 18 is a diagram illustrating an embodiment of a Deep Dict compressor 200. The two major components of the Deep Dict compressor 200 are a Bernoulli Transformer AutoEncoder (BTAE) 202 and a distortion constraint module 204. As shown in FIG. 18, the BTAE 202 includes an encoder 206, a binarization unit 208, and a decoder 210. The input and output of the BTAE 202 are provided to a subtraction unit 212 configured to output the residuals r, which are provided to the distortion constraint module 204. The distortion constraint module 204 includes a quantization unit 214 and an entropy coder 216.

Initially, the Deep Dict compressor 200 divides the original long time-series into smaller time-series (x) chunks by a time window. The BTAE 202 encodes x into Bernoulli latent states (c) and decodes c to predict time-series (x′). In order to limit the error of reconstructed time-series to a desired range, the residual (r=x−x′) is quantized uniformly to r_{q} and an entropy coder is used to compress r_{encoded} in a lossless manner. The value c, the decoder, and r_{encoded} are used for transmission or storage after compression. During decompression, c is fed to the decoder to recover x′, and the entropy coder decodes r_{encoded} to r_{q}. The time-series reconstruction is formulated as x_{recon}=+r_{q}. Thus, the quantization error determines the distortion of reconstructed time-series. During decompression, c functions as indices and BTAE's decoder serves as a dictionary.

The BTAE 202 seeks to discover the Bernoulli latent states/representations of a time-series and to recover the time-series from the representations. The encoder takes the flattened time-series x as input and transforms it into real-value latent states y, which are then binarized to Bernoulli latent states c as shown in Eq. 1 below, where tan h approximation is used to make the binarization function differentiable.

$${f}_{binarization} ( {y}_{i} ) = \begin{matrix} & 1 : & if {y}_{i} \geq 0 \\ or & - 1 : & else\end{matrix} \qquad ( 1 )$$

FIG. 19 is a diagram illustrating an embodiment of the decoder 210 of the BTAE 202 shown in FIG. 18. In this example, the decoder 210 includes a Feed Forward Network (FFN) 220, an expander unit 222, a positional encoding device 224, an adder 226, a transformer 228, and another FFN 230. In this embodiments, the transformer 228 may include a layer norm unit 232, a multi-head attention unit 234, another adder 236, another layer norm unit 238, another FFN 240, and another adder 242.

Consequently, the derivative of the binarization function of the binarization unit 208 is computed as in Eq. 2:

df_{binarization}/dyᵢ=1−tanh²(yᵢ) (2)

A transformer-based decoder is then fed with the Bernoulli latent states (c) to predict the corresponding time-series. Since c contains limited information, the FFN 220 is used as the encoder. The FFN 220 augments c∈{−1, 1}^{|c|} to c′∈ [symbol] which is then replicated to c″∈ [symbol] where [symbol] is the length of time-series, and [symbol] is considered as one of important hyperparameters of Deep Dict. To avoid additional overhead of parameters in positional encoding, sine and cosine functions are used as seen in Eqs. 3-4, and c″ with positional encoding is fed into the transformer 228 encoder blocks followed by the FFN 230 to obtain the prediction of time-series.

P E(pos,2i)=sin(pos/10000^{2i/dmodel}) (3)

P E(pos,2i+1)=cos(pos/10000^{2i/dmodel}) (4)

The BTAE 202 may be configured to employ 32-bit float for the training phase, and 16-bit float for validation and testing to decrease the size of the decoder 210. Time-series datasets may contain recurring or similar patterns. Hence, not all Bernoulli hidden states are unique. Encoding Bernoulli latent states with an entropy encoder 216 can further improve the compression ratio.

In comparison to the traditional AE, the BTAE 202 reduces the size of the latent state by a factor of the size of number of bits of a float point |F P|; for example, |F P|=32 bits by default in Pytorch and TensorFlow. Due to its non-autoregressive architecture, the system 200 leads to faster training and performs better on long sequences than RNN models such as LSTM and GRU in terms of compression ratio.

It may take a long time and many computational resources to train a new model from scratch each time a new time-series is compressed. Therefore, transfer learning can be used to accelerate the compression process. For univariate time-series, a trained model can be directly applied to another, whereas for a multivariate time-series, the encoder 206, and the last FFN 230 of the decoder 210 have to be retrained from scratch due to the varying number of multivariate variables.

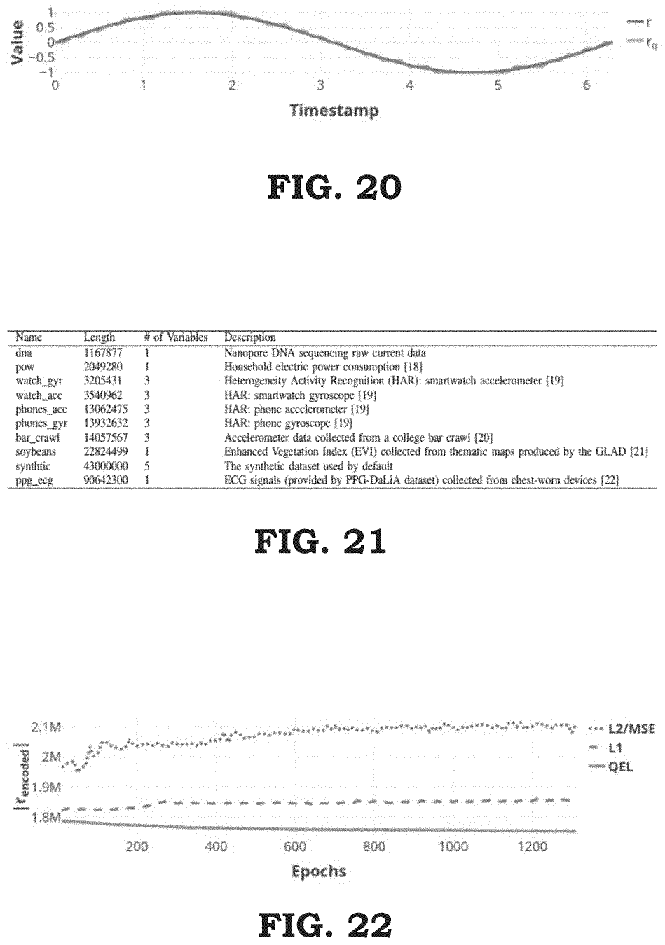

FIG. 20 is a graph illustrating an example of uniformed quantization. Regarding distortion constraint module 204 shown in FIG. 18, the predicted time-series x′ typically has more than 10% Mean Absolute Percentage Error (MAPE) loss. By utilizing the BTAE 202, distortion can be constrained to a small range at the expense of more parameters. Thus, with limited number of parameters in the BTAE 202, the distortion constraint module 204 may be utilized to reduce the distortion to a desired range. As depicted in FIG. 20, r may be quantized uniformly to r_{q} as follows: r_{q}=2∈*round(r/2∈, where ∈ is the desired MaAE. To avoid float-point overflow, r_{q} is stored in 64-bit format. Adaptive Quantized Local Frequency Coding (e.g., powered by libbsc or other library for lossless compression) may be used as the entropy coder 216 to encode r_{q} as r_{encoded} in the present disclosure.

The Quantized Entropy Loss (QEL) is defined herein. In general, many ML-based compression schemes contain quantization and entropy coders and apply trivial L1/L2 as loss function. Nevertheless, because of the entropy coder 216, the size of r_{encoded} is constrained by the total entropy of r_{q}. Since common regression losses such as L1/L2 do not consider quantization nor minimizing entropy of r_{q}, they do not describe the problem precisely. The embodiments of the present disclosure are configured to introduce this new loss function, referred to as QEL, so as to minimize the size of r_{encoded}. In addition, QEL is not specific to the Deep Dict system 200. Rather, it is a loss function applicable to all compression methods that employ uniform quantization followed by an entropy coder.

To formulate QEL, certain symbols are defined for clarification. Given E as the desired MaAE, r_{q}=2∈*round(r/2∈). S={s1, s2, . . . , s|S|} is the set of unique values of r_{q} whereas n(sⱼ) is a counter to keep track of the number of times sⱼ appears in r_{q}, and p(sⱼ) specifies the probability of sⱼ appearing in r_{q}, where |⋅| counts the number of items in ⋅. A formal expression of p(sⱼ) can be given as n(sⱼ)/|r_{q}|.

As stated in Eq. 5, the size of r_{encoded} is always greater than the total entropy of rq due to the nature of the entropy coder. Good-performing entropy coders with high compression ratio tend to approach the limitation.

|r_{encoded}|≥−Σⱼ₌₀^{|S|}n(sj)log p(sj) (5)

In light of these, the objective function can be formulated as in Eq. 6:

min(r)H(r)=−Σⱼ₌₀^{|S|}p(sj)log p(sj) (6)

However, since neither the probability (p) nor the counter (n) is differentiable, P may be defined to replace p as shown in Eq. 7.

$$\partial H / \partial ri \approx \partial H / \partial P * \partial P / \partial {g}^{′} ϵ * \partial {g}^{′} ϵ / \partial ri \approx - {\sum }_{j = 0}^{\vert S \vert} [ 1 + ln P ( r - sj ) ] * 1 / \vert r \vert * ( - b {{ϵ}^{b} ( ri - sj )}^{b - 1} ) / ( {[ {{ϵ}^{b} ( ri - sj )}^{b + 1} ]}^{2} ) \approx b {ϵ}^{b} / \vert r \vert {\sum }_{j = 0}^{\vert S \vert} [ 1 + ln P ( sj ) ] ( {d}^{b - 1} ) {/ [ {ϵ}^{b} {{d}_{ij}}^{b - 1} {d}_{ij} + 1 ]}^{2} \qquad ( 11 )$$

To make g∈ differentiable, g∈ is approximated as g′∈ in Eq. 9:

g∈≈g′∈=1(∈x)b+1 (9)

where g∈=limb→∞g′∈. Under the circumstances, the objective function can be reformulated as Eq. 10:

H(r)≈−Σⱼ₌₀^{|S|}P(r−sj)∈(xk) (10)

With these in mind, once the first order derivative of H is taken, it will appear as in Eq. 11:

$$P ( x ) = 1 / \vert x \vert - {\sum }_{k = 0}^{\vert x \vert} g ϵ ( xk ) \qquad ( 7 )$$

$$where g ϵ ( x ) = \begin{matrix}1 : & if - ϵ \leq x < ϵ \\ or 0 : & else\end{matrix} \qquad ( 8 )$$

where dᵢⱼ=rᵢ−sᵢ. Furthermore, QEL can be easily generalized to multidimensional matrix as presented in Eq. 12 where ⋅ is the index of r's elements, and d⋅j=r⋅−sⱼ

∂H/∂r⋅≈b∈^{b}/|r|+Σⱼ₌₀^{|S|}[1+ln p(sj)](d_{⋅j}^{b-1})/[∈^{b}d_{⋅j}^{b-1}d_{⋅j}+1]² (12)

To accelerate the process, the forward procedure sticks with the objective function formulation in Eq. 6, utilizes the occurrences of unique values of r_{q}, and saves S and p(sⱼ) for backward procedure, while the backward process constructs the distance matrix D=[d_{⋅j}]_{⋅*j} and uses Eq. 12 to calculate derivatives.

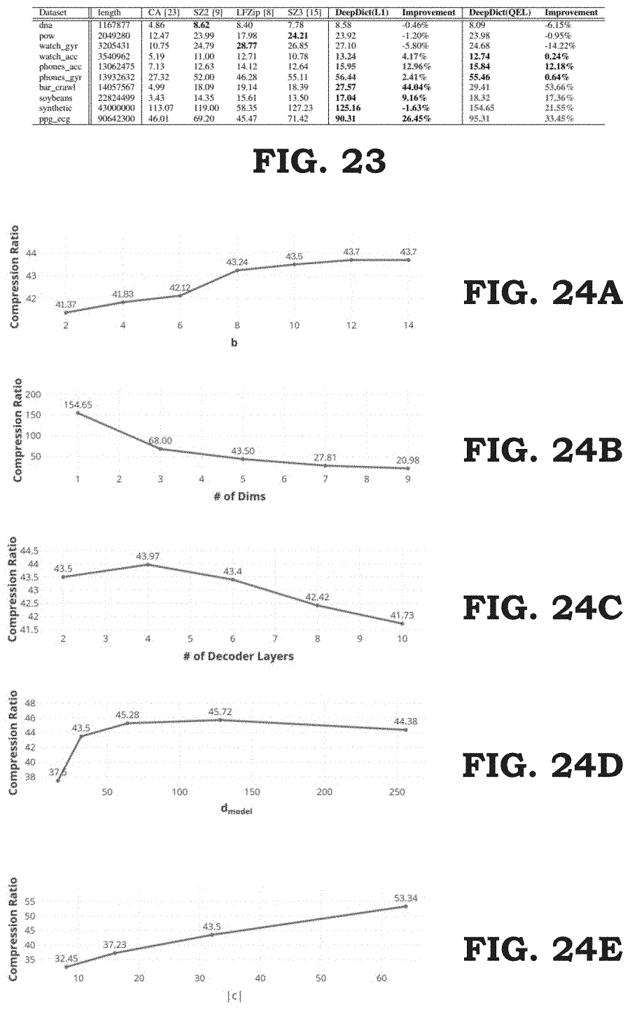

FIG. 21 is a table illustrating an example of datasets used for testing the compression system of FIG. 17. FIG. 22 is a graph illustrating a comparison among different compression techniques using a specific dataset. FIG. 23 is a table showing a comparison of the compression ratios of different compression techniques under a 0.1 MaAE. FIGS. 24A-24E are graphs showing the effect of different variables on the compression ratio.

The table of FIG. 23 provides a summary of the datasets used for evaluation, ordered by the length of time-series. The datasets cover various domains containing sensor data from mobile devices and smartwatches, agriculture data, DNA data, and ECG data. The time-series datasets are accessible to the general public via the UCI ML Repository and Kaggle datasets. To investigate the effects of the length of the time-series and the number of variables on the proposed method, the systems and methods of the present disclosure generate additional polynomial synthetic datasets as follows.

Timestamp t=[t_{low}, . . . , t_{high}]^{T}∈ [symbol] determines the length of a time-series. Polynomial timestamp is tₚ=[t⁰, t¹, . . . , t^{d}]T∈ [symbol] where dₚ is the degree of polynomial. To introduce randomness into synthetic data, the coefficient C∈ [symbol] is randomly generated. A time-series is defined as x=(C×tₚ)^{T}∈ [symbol] and the concatenation of multiple x forms a long sequence.

The datasets listed include both multivariate and univariate time-series. The first variable is utilized as a univariate dataset for these multivariate time-series; for instance, the univariate dataset of watch_gyr indicates that only the x-axis is utilized; and univariate mode indicates that the multivariate time-series is flattened prior to being fed into compressors.

To evaluate the performance of Deep Dict, five lossy time-series compressors were used as baselines. These compressors include Critical Aperture (CA)1, SZ22, LFZip3, and SZ34. CA is an industrially well-received compressor that is computationally simple and efficient. The evaluation also utilized the most recent versions of SZ2 (version 2.1.12.2) and SZ3 (version 3.1.5.3), which are the state-of-the-art prediction-based compressors. LFZip is a cutting edge framework for prediction-quantization-entropy that uses bidirectional GRU to capture nonlinear structure.

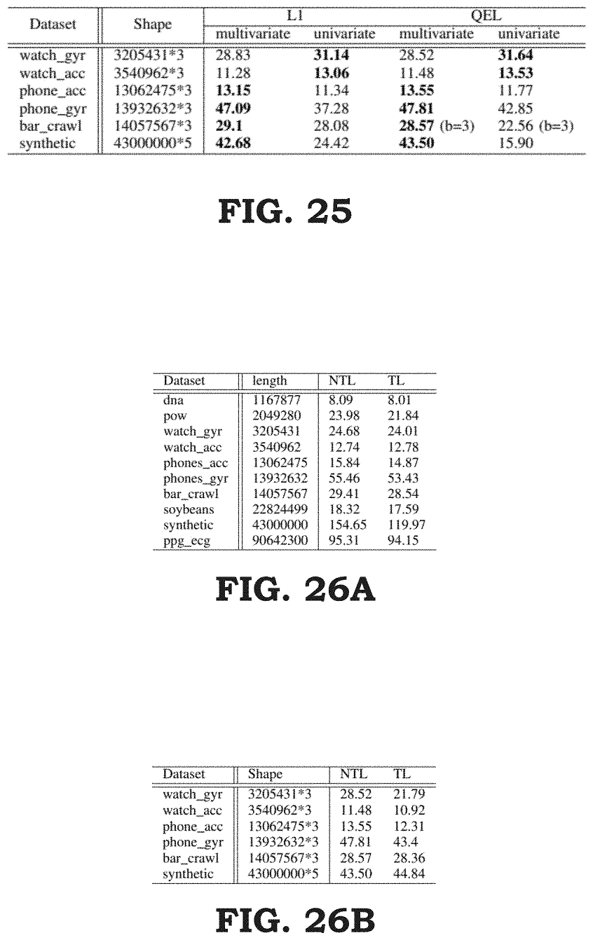

The table of FIG. 25 compares the strategy utilized by the embodiments of the present disclosure to the baselines under the datasets that are ordered with respect to the length of their time-series. Under seven out of ten datasets, the methods of the present disclosure outperformed the state-of-the-art algorithms. Due to the overhead of BTAE and codes, Deep Dict performs similarly to the baseline on small datasets. However, under large datasets, Deep Dict outperforms the baselines by at most 53.66%. Since the majority of time-series datasets are noisy, L1 loss is utilized. The testing compared the QEL loss and L1 loss for further analysis as presented in the table of FIG. 25. As the size of the datasets increased, QEL outperformed L1 under four datasets (marked as green). As depicted in FIG. 22, when the bar crawl dataset was considered as a representative example, because L1 and L2 are not particularly designed to reduce the size of r_{encoded}, L1 and L2 losses resulted in an increase of |r_{encoded}| during the training process; however, QEL could handle such situations and increased the compression ratio.

Regarding the results under multi-variate datasets, six of the ten datasets listed in the table of FIG. 23 contain multivariate time-series. The table of FIG. 25 compared compression ratio between univariate and multivariate modes to show the performance of the univariate mode (i.e., flattening the MTS prior to feeding into Deep Dict) and multivariate mode. Due to the fact that flattening MTS increased the size of the Bernoulli latent states (c) by the dimensions, the compression ratio of multivariate mode improves as the length and dimension increase. The default value of b was set at 10; however, since the bar crawl dataset contains extremely large values (greater than 108), a large b will lead to float-point overflow in the derivative, as shown in Eq. 12, resulting in NaN in BTAE's outputs. Therefore, b was set to 3 for this dataset. QEL outperformed L1 and L2 under all datasets except for the bar crawl dataset.

Regarding transferability, training a new model for each time-series from scratch is inefficient and time-consuming. Transfer learning is used to accelerate the compression process. The model is initially pre-trained using the largest dataset (i.e., ppg_ecg for univariate datasets and synthetic for multivariate datasets), and then fine-tuned for just 10 epochs with the remaining datasets. As shown in the table of FIG. 26A, the compression ratio of Deep Dict with transfer learning (Deep Dict+TL) reduces by less than 5% under 7 out of 10 univariate datasets when compared to training a model from scratch. On five out of seven univariate datasets (where Deep Dict outperforms the best baseline), Deep Dict+TL continue to outperform the best baseline. The table shown in FIG. 26B shows the comparative results between NTL and TL for multivariate datasets. Under five out of six multivariate datasets, Deep Dict+TL decreases the compression ratio by less than 10%. Experimental results indicate that Deep Dict can achieve considerably higher speed without sacrificing significant compression ratio.

In a last step of an empirical study, a series of empirical studies were conducted concerning the impact of hyper-parameters and data size. As defined by Eq. 9, a large b improves the precision of the approximation, but it may also cause the derivative float-point overflow. As shown in FIG. 24A, compression ratio increases with b. When b>6, QEL performs better than L1 loss. The variable b=10 is regarded as the default value, since, based on experiments, it does not result in float-point overflow and b values that are more than 10 do not provide significant advantages. Previous results indicate that Deep Dict outperforms the baselines under large time-series datasets. FIG. 24B illustrates the effect of the dimensionality on compression ratio (with the same hyperparameters). As network size cannot be increased, Deep Dict's compression ratio is limited by the number of parameters. There are two ways to increase the number of parameters: stacking more layers and expanding the network. As shown in FIG. 24C, stacking more transformer encoders does not result in a significant improvement; rather, as the number of layers increases, the compression ratio decreases because of the increase in the decoder size. On the other hand, FIG. 24D demonstrates that compression ratio can be improved with a large d_{model}. It is worth noting that large d_{model} is not suitable for small datasets since large d_{model} will notably increase the number of parameters in BTAE. FIG. 24E depicts the variation of compression ratio under varying Bernoulli latent states (|c|). Increasing |c| is possible to considerably enhance Deep Dict performance for big datasets, although, similar to d_{model}, a large |c| can also increase the number of parameters. In summary, increasing b, d_{model}, and |c| can further enhance the performance of long time-series.

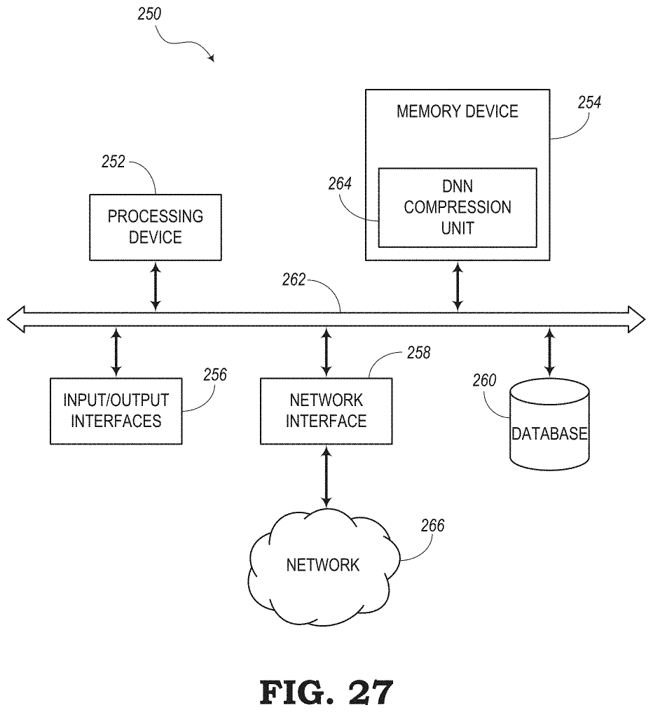

FIG. 27 is a diagram illustrating an embodiment of a computing device 250 for performing compression techniques. The computing device 250 includes a processing device 252, a memory device 254, Input/Output (I/O) interfaces 256, a network interface 258, a database 260, each interconnected via a local bus interface 262. The network interface 258 may be configured to communicate with one or more NEs 12 via a network 266. The computing device 250 may include a DNN compression unit 264 configured to perform the various compression or DNN deployment processes described in the present disclosure. The DNN compression unit 264 allow network data, such as telemetry or PM data, to be obtained via the network 266. Then, the DNN compression unit 264 is configured to train a DNN to hold or store the network data, whereby the data can later be retrieved using a predictive algorithm of the DNN. The DNN compression unit 264 may be stored in any suitable combination of software or firmware in the memory device 254 and hardware configured in the processing device 252. The DNN compression unit 264 may be configured in a non-transitory computer-readable media and may enable the processing device 252 to perform the compression techniques described herein. The computing device 250 may be a Network Element (NE), a control device (e.g., part of a Network Management System (NMS)), or the like.

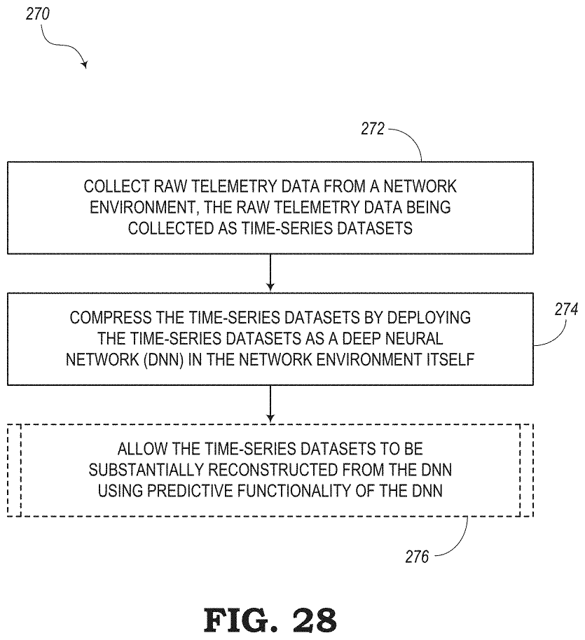

FIG. 28 is a flow diagram illustrating an embodiment of a process 270 for performing a compression technique, which may be part of the DNN compression unit 264 described with respect to FIG. 27. The process 270 includes the step of collecting raw telemetry data from a network environment, as indicated in block 272. The raw telemetry data may be collected as time-series datasets. Also, the process 270 includes the step of compressing the time-series datasets by deploying the time-series datasets as a Deep Neural Network (DNN) in the network environment itself, as indicated in block 274. For example, the time-series datasets may then be configured to be substantially reconstructed from the DNN using predictive functionality of the DNN, as indicated in block 276.

Furthermore, the raw telemetry data may be network data collected from a communications network. For example, the raw telemetry data may include information related to a) packet count, b) latency, c) jitter, d) SNR, e) SNR estimates, f) state of polarization, g) Channel Quality Indicator (CQI) reports, h) alarm states, and the like. The step of compressing the time-series datasets may include dividing the raw telemetry data into equal-sized chunks of time, feeding indices as inputs to the DNN to obtain the equal-sized chunks of time as outputs from the DNN, and training the DNN to adjust weights until a desired compression ratio or precision is achieved.

The process 270 may further include the step of substantially reconstruct the time-series datasets by a) receiving an index corresponding to a desired time range associated with a desired time-series dataset, b) inputting the index to the trained DNN, and c) propagating values through the DNN to substantially decompress the desired time-series dataset at the output of the DNN. A telemetry device may be configured to prune the raw telemetry data before transmitting the raw telemetry data for collection. The process 270 may also include a) detecting a quality factor of a data decompression process related to reconstruction, b) providing a feedback signal to change the parameters of a pruning process associated with the telemetry device in order to reduce a reconstruction error; and c) adjusting the pruning level of the pruning process using Reinforcement Learning.

The step of deploying the time-series datasets as the DNN in the network environment may include applying the DNN to a host server. The host server, for example, may be configured to allow a query request of the DNN for data retrieval. The process 270 may also include creating the DNN with indices and relationships between each index and a respective time-series dataset. In response to receiving an index for a query request, the DNN is configured to substantially reconstruct a time-series bucket related to the index. Creating the DNN may include picking the indices randomly or according to a pattern and/or may include determining the indices with respect to a bottleneck of an autoencoder. Also, creating the DNN may include forming multiple dense layers and/or may include using a decoder of an autoencoder.

The step of compressing the time-series datasets may include a step of compressing the time-series datasets at multiple different compression rates and at different precisions depending on a size of a value included in the different time-series datasets. The compressing step may also include increasing the compression rate by using a Bernoulli Transformer AutoEncoder (BTAE) so as to compress the time-series datasets into Bernoulli distributed latent states and constraint the distortion of reconstructed time-series datasets. The BTAE may include an encoder acting as a feed-forward device and the decoder acting as a dictionary. Also, the BTAE may be configured to reduce the size of a latent state by a factor related to the number of bits of floating point numbers used for the values of the time-series datasets.

Substantially reconstructing the time-series datasets may include transforming the time-series datasets to the frequency domain. The process 270 may also include determining residuals as a difference between outputs of a reconstruction process and the raw telemetry data and then compressing the residuals. The process 270 may also perform a prediction-quantization-entropy coding scheme, wherein a prediction procedure is related to a decoding element of an autoencoder, and wherein quantization and entropy procedures are related to a distortion constraint element for processing the residuals. Also, the process 270 can determine quantized entropy loss to constrain the size of an encoded residual with respect to total entropy.

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A non-transitory computer-readable medium configured to store computer logic having instructions for enabling a processing system to:
collect raw telemetry data from a network environment, the raw telemetry data being collected as time-series datasets; and
compress the time-series datasets by deploying the time-series datasets as a Deep Neural Network (DNN) in the network environment itself;
wherein the time-series datasets are configured to be substantially reconstructed from the DNN using predictive functionality of the DNN.

2. The non-transitory computer-readable medium of claim 1, wherein the raw telemetry data is network data collected from a communications network, and wherein the raw telemetry data includes information related to one or more of packet count, latency, jitter, Signal-to-Noise Ratio (SNR), SNR estimates, state of polarization, Channel Quality Indicator (CQI) reports, and alarm states.

3. The non-transitory computer-readable medium of claim 1, wherein the instructions further enable the processing system to compress the time-series datasets by:
dividing the raw telemetry data into equal-sized chunks of time;
feeding indices as inputs to the DNN and obtaining the equal-sized chunks of time as outputs from the DNN; and
training the DNN to adjust weights until a desired compression ratio or precision is achieved.

4. The non-transitory computer-readable medium of claim 1, wherein the instructions further enable the processing system to substantially reconstruct the time-series datasets by:
receiving an index corresponding to a desired time range associated with a desired time-series dataset;
inputting the index to the trained DNN; and
propagating values through the DNN to substantially decompress the desired time-series dataset at the output of the DNN.

5. The non-transitory computer-readable medium of claim 1, wherein a telemetry device is configured to prune the raw telemetry data before transmitting the raw telemetry data for collection.

6. The non-transitory computer-readable medium of claim 5, wherein the instructions further enable the processing system to:
detect a quality factor of a data decompression process related to reconstruction;
provide a feedback signal to change the parameters of a pruning process associated with the telemetry device in order to reduce a reconstruction error; and
adjust pruning level of the pruning process using Reinforcement Learning.

7. The non-transitory computer-readable medium of claim 1, wherein deploying the time-series datasets as the DNN in the network environment includes applying the DNN to a host server, the host server configured to allow a query request of the DNN for data retrieval.

8. The non-transitory computer-readable medium of claim 1, wherein the instructions further enable the processing system to create the DNN with indices and relationships between each index and a respective time-series dataset, and wherein, in response to receiving an index for a query request, the DNN is configured to substantially reconstruct a time-series bucket related to the index.

9. The non-transitory computer-readable medium of claim 8, wherein creating the DNN includes:
picking the indices randomly or according to a pattern; and/or
determining the indices with respect to a bottleneck of an autoencoder.

10. The non-transitory computer-readable medium of claim 8, wherein creating the DNN includes:
forming multiple dense layers; and/or
using a decoder of an autoencoder.

11. The non-transitory computer-readable medium of claim 1, wherein compressing the time-series datasets includes compressing the time-series datasets at multiple different compression rates and at different precisions depending on a size of a numeric value included in the different time-series datasets.

12. The non-transitory computer-readable medium of claim 1, wherein compressing the time-series datasets includes increasing the compression rate by using a Bernoulli Transformer AutoEncoder (BTAE) so as to compress the time-series datasets into Bernoulli distributed latent states and constraint the distortion of reconstructed time-series datasets.

13. The non-transitory computer-readable medium of claim 12, wherein the BTAE includes an encoder acting as a feed-forward device and the decoder acting as a dictionary.

14. The non-transitory computer-readable medium of claim 12, wherein the BTAE is configured to reduce the size of a latent state by a factor related to the number of bits of floating point numbers used for the values of the time-series datasets.

15. The non-transitory computer-readable medium of claim 1, wherein substantially reconstructing the time-series datasets includes transforming the time-series datasets to the frequency domain.

16. The non-transitory computer-readable medium of claim 1, wherein the instructions further enable the processing system to:
determine residuals as a difference between outputs of a reconstruction process and the raw telemetry data; and
compress the residuals.

17. The non-transitory computer-readable medium of claim 16, wherein the instructions further enable the processing system to perform a prediction-quantization-entropy coding scheme, whereby a prediction procedure is related to a decoding element of an autoencoder, and whereby quantization and entropy procedures are related to a distortion constraint element for processing the residuals.

18. The non-transitory computer-readable medium of claim 1, wherein the instructions further enable the processing system to determine quantized entropy loss to constrain the size of an encoded residual with respect to total entropy.

19. A system comprising:
a processing device and
a memory device configured to store computer logic having instructions that, when executed, enable the processing device to
collect raw telemetry data from a network environment, the raw telemetry data being collected as time-series datasets, and
compress the time-series datasets by deploying the time-series datasets as a Deep Neural Network (DNN) in the network environment itself,
wherein the time-series datasets are configured to be substantially reconstructed from the DNN using predictive functionality of the DNN.

20. A method comprising the steps of:
collecting raw telemetry data from a network environment, the raw telemetry data being collected as time-series datasets; and
compressing the time-series datasets by deploying the time-series datasets as a Deep Neural Network (DNN) in the network environment itself;
wherein the time-series datasets are configured to be substantially reconstructed from the DNN using predictive functionality of the DNN.
